(19) United States
(12) Patent Application Publication
(10) Pub. No.: US 2008/0135015 A1
(43) Pub. Date: Jun. 12, 2008

(54) Method for operating an internal combustion engine

(75) Inventor: Paul Kapus, Judendorf (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 11/987,912

(22) Filed: Dec. 5, 2007

(30) Foreign Application Priority Data
Dec. 7, 2006 (AT) A 2031/2006

(51) Int. Cl. F02D 41/30

(52) U.S. Cl. 123/299; 123/575; 701/103

(57) ABSTRACT

Fuel, especially ethanol, is injected in an internal combustion engine via at least one injection device into a combustion chamber, with the injection pressure of the fuel being temporarily increased during the starting phase of the internal combustion engine. The injected fuel quantity is divided among several injections in the intake phase during the start of the internal combustion engine, with at least two injections being performed during the intake phase and with the multiple injections being performed with high injection pressure already in the dragging phase for the first injections. The starting behavior can be improved when the quantity of fuel of the last fuel injection is lower than the quantity of each preceding fuel injection.

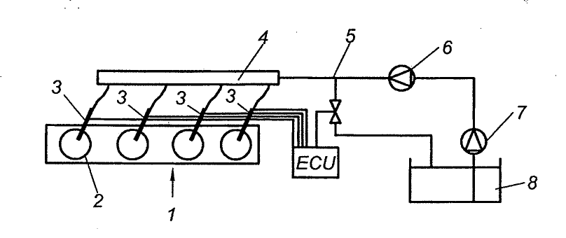

### FIELD OF THE INVENTION

The invention relates to a method for operating an internal combustion engine, in which the fuel, especially ethanol, is injected via at least one injection device into a combustion chamber, with the injection pressure of the fuel being temporarily increased during the starting phase of the internal combustion engine, with the injected fuel quantity being divided into several injections in the intake phase during the start of the internal combustion engine, with at least two injections being performed during the intake phase and with the multiple injections with high injection pressure being performed already in the dragging phase for the first injections.

### BACKGROUND OF THE INVENTION

US 2003/0145830 A1 discloses a method for operating an internal combustion engine which provides that the fuel pressure is increased at least temporarily in an idle state of the internal combustion engine in order to ensure secure starting in the internal combustion engine. Vapor bubbles in the fuel lines should thus be avoided.

JP 11-270385 A2 discloses an injection system for an internal combustion engine in which the injection pressure is increased during the starting phase in order to enable rapid starting of the internal combustion engine.

EP 1 728 997 A2 describes a control apparatus for an internal combustion engine with injection via intake manifold, with the fuel supply pressure being increased briefly during the starting phase in order to reduce the emissions during the start of the internal combustion engine. The injection devices of spark-ignition engines with intake-manifold fuel injection are supplied via a conventional fuel pump with a pressure between 3 bar to 4 bar. The maximum pressure of fuel pumps is usually approximately 5 bar. This pressure is not sufficient in order to improve the starting behavior in ethanol-containing fuels.

DE 102 42 227 A1 describes a method for operating an internal combustion engine with direct fuel injection, with a high-pressure or low-pressure start being chosen during the start of the internal combustion engine depending on a minimum fuel pressure built up in the injection apparatus within a defined number of cycles. The minimum fuel pressure and the number of cycles are chosen depending on the combustion chamber temperature, with the injection of the fuel into the combustion chamber occurring in a cycled manner during the starting operation. This is to reduce the wetting of the combustion chamber wall with fuel during the injection process and to form a combustible mixture cloud in the combustion chamber of the internal combustion engine close to the ignition source. In the case of DE 102 42 227 A1, starting occurs with low pressure and, after a number of cycles, it is switched over to high-pressure injection. Favorable nebulizing is achieved by the cycled injection. Although this is sufficient for gasoline fuels, it is not for ethanol. The starting of the internal combustion engine with injection pressures beneath 20 bar is not possible at low temperatures especially in the case of ethanol fuels.

Cold starting is often problematic especially in the case of ethanol-containing fuels due to the fuel properties. It is necessary to start with a preheating device for the air intake or the fuel. This increases the constructional complexity however and comes with the disadvantage that the battery is additionally strained during the start of the internal combustion engine.

### SUMMARY OF THE INVENTION

It is the object of the present invention to avoid such disadvantages and to improve the starting behavior of a spark-ignited internal combustion engine with little effort.

This is achieved in accordance with the invention in such a way that the quantity of the fuel of the last fuel injection is lower than the quantity of any preceding fuel injection.

Because the fuel is injected with high pressure during the starting phase it is possible to ensure that the fuel remains floating in the combustion chamber, as a result of which the starting quantity and/or starting temperature can be reduced. The high fuel pressure enables short injection periods. The multiple injection is already performed during the dragging phase for the first injections, i.e. when the crankshaft is still being turned by the starter.

As a result of a plurality of small short injections it is ensured that the fuel does not come into contact with the walls of the combustion chamber.

It is especially advantageous when four injections are injected into the combustion chamber during the intake phase, thus leading to the formation of a homogeneous mixture in the combustion chamber. It is further advantageous for increasing the ignitability when a final fuel injection is performed during the compression phase, with the last fuel injection preferably being directed into the area of the ignition device.

As a result of the small quantity of the last injection, the application on the walls of the combustion chamber can be avoided. Since the last fuel injection occurs towards the ignition device, a stratified charge is available for the ignition. The method can be used especially advantageously for the fuels of gasoline and ethanol or any desired mixtures thereof or for random fuel mixtures which contain gasoline or ethanol.

The invention is explained below in closer detail by reference to the drawing.

### BRIEF DESCRIPTION OF THE DRAWING

The FIGURE shows schematically an internal combustion engine.

### DETAILED DESCRIPTION OF THE DRAWING

It schematically shows an internal combustion engine 1 with several cylinders 2, with fuel being injected directly into the respective combustion chamber via an injection device 3 each. The injection system comprises a fuel manifold 4 into which a fuel line 5 opens. A high-pressure pump 6 is arranged in the fuel line 5 which possibly removes fuel via a preliminary pump 7 from a fuel tank. The control valve 9 can be used to control the pressure in the fuel line 5 depending on the operational state of the engine via an electronic control unit ECU.

What is claimed:

1. A method for operating an internal combustion engine, in which a fuel, especially ethanol, is injected via at least one injection device into a combustion chamber, with an injection pressure of the fuel being temporarily increased during the starting phase of the internal combustion engine, with an injected fuel quantity being divided into several injections in an intake phase during the start of the internal combustion engine, with at least two injections being performed during the intake phase and with the several injections with high injection pressure being performed already in a dragging phase for first injections, wherein the quantity of the fuel of a final fuel injection is lower than the quantity of each preceding fuel injection.

2. A method according to claim 1, wherein the final fuel injection is performed during the compression phase.

3. A method according to claim 2, wherein the final fuel injection is directed into the region of the ignition device.

4. A method according to claim 1, wherein the injection is made directly into the combustion chamber.

5. A method according to claim 1, wherein the fuel is chosen from a group of gasoline, ethanol, a mixture of gasoline and ethanol, or a fuel mixture containing gasoline or ethanol.

6. A method according to claim 1, wherein a injection period of the final fuel injection is shorter than 2 ms, and that the injection pressure during the starting phase is at least 20 bar.

7. A method according to claim 1, wherein at least three injections are performed during the intake phase.

8. A method according to claim 1, wherein at least four injections are performed during the intake phase.
